(19) United States
(12) Patent Application Publication
(10) Pub. No.: US 2025/0094362 A1
(43) Pub. Date: Mar. 20, 2025

(54) SYSTEM AND METHOD OF MANAGING AN OPTIMAL PORT SETUP FOR WORKSPACES

(71) Applicant: Dell Products, L.P., Round Rock, TX (US)

(72) Inventors: Fnu Jasleen, Austin, TX (US); Michael S. Gatson, Austin, TX (US); Shailesh Jain, Kalyan (IN)

(73) Assignee: Dell Products, L.P., Round Rock, TX (US)

(21) Appl. No.: 18/469,070

(22) Filed: Sep. 18, 2023

(51) Int. Cl. G06F 13/10; G06F 13/38

(52) U.S. Cl. CPC G06F 13/102; G06F 13/385

(57) ABSTRACT

Systems and methods of managing an optimal port setup for workspaces are described. In an illustrative, non-limiting embodiment, an Information Handling System (IHS) may include: a processor; and a memory coupled to the processor, the memory having program instructions stored thereon that, upon execution, cause the IHS to: obtain information for a plurality of peripheral devices coupled to at least some of a plurality of ports of the IHS in a first configuration; and recommend a second configuration for connecting one or more of the plurality of peripheral devices to one or more of the plurality of ports of the IHS based, at least in part, on the information.

### FIELD

This disclosure relates generally to Information Handling Systems, and, more specifically, to systems and methods of managing an optimal port setup for workspaces.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods of managing an optimal port setup for workspaces are described. In an illustrative, non-limiting embodiment, an Information Handling System (IHS) may include: a processor; and a memory coupled to the processor, the memory having program instructions stored thereon that, upon execution, cause the IHS to: obtain information for a plurality of peripheral devices coupled to at least some of a plurality of ports of the IHS in a first configuration; and recommend a second configuration for connecting one or more of the plurality of peripheral devices to one or more of the plurality of ports of the IHS based, at least in part, on the information.

In some embodiments, the second configuration includes connection information for at least one peripheral device of the plurality of peripheral devices to a respective port of the plurality of ports. In some embodiments, the plurality of ports include one or more higher speed ports configured to communicate with the peripheral devices at higher communication speeds than one or more lower speed ports, where the second recommendation includes a recommendation for a first set of the plurality of peripheral devices to connect to the one or more high speed ports, and a second set of the plurality of peripheral devices to connect to the one or more lower speed ports.

In some embodiments, the program instructions, upon execution, further cause the IHS to obtain the information via a composite peripheral device including a plurality of ports. In some embodiments, the composite peripheral device includes at least one of: a docking station, a display, or a hub.

In some embodiments, to obtain information for the plurality of peripheral devices, the program instructions, upon execution, further cause the IHS to: obtain identifying information for individual ones of the plurality of peripheral devices; obtain respective maximum speed requirements of the individual ones of the plurality of peripheral devices based, at least in part, on the identifying information; obtain usage information for the individual ones of the plurality of peripheral devices; and determine actual speeds used by the individual ones of the plurality of peripheral devices based, at least in part, on the respective maximum speed requirements and the usage information for the individual ones of the plurality of peripheral devices.

In some embodiments, the maximum speed requirements of the individual ones of the plurality of peripheral devices are obtained from a golden configuration datastore. In some embodiments, the actual speeds used by the individual ones of the plurality of peripheral devices are determined by a machine learning algorithm based, at least in part, on the respective maximum speed requirements and the usage information for the individual ones of the plurality of peripheral devices.

In some embodiments, to recommend the second configuration, the program instructions, upon execution, further cause the IHS to: determine respective actual speeds used by individual ones of the plurality of peripheral devices; and execute a knapsack algorithm to determine a best fit for connecting the plurality of peripheral devices to the plurality of ports based, at least in part, on the respective actual speeds used by the individual ones of the plurality of peripheral devices.

In some embodiments, to recommend the second configuration, the program instructions, upon execution, further cause the IHS to: execute a knapsack algorithm to determine a best fit for connecting the plurality of peripheral devices to the plurality of ports based, at least in part, on one or more of the following criteria: (a) actual speeds required by individual ones of the plurality of peripheral devices, (b) priority of the individual ones of the plurality of peripheral devices based, at least in part, on respective times the respective individual ones of the plurality of peripheral devices are connected to the IHS, (c) power requirements of the individual ones of the plurality of peripheral devices, or (d) usage time by an end user of the individual ones of the plurality of peripheral devices.

In some embodiments, the peripheral devices include at least one of: a docking station, a display, a projector, a camera, a microphone, a loudspeaker, headphones, a keyboard, a mouse, a scanner, a printer, or a tablet. In some embodiments, to obtain information for the plurality of peripheral devices, the program instructions, upon execution, further cause the IHS to: monitor a utilization of at least one of the peripheral devices via a port selected from the group consisting of: Universal Serial Bus (USB) Type-A, USB Type-B, USB Type-C, Lightning, Firewire, Thunderbolt, DisplayPort, High-Definition Multimedia Interface (HDMI), Digital Visual Interface (DVI), and Serial Advanced Technology Attachment (SATA).

In another illustrative, non-limiting embodiment, a method may include: obtaining actual speed information for a plurality of peripheral devices coupled to at least some of a plurality of ports of an Information Handling System (IHS) in a first configuration; and recommending a second configuration for connecting one or more of the plurality of peripheral devices to one or more of the plurality of ports based, at least in part, on the actual speed information.

In some embodiments, obtaining the actual speed information for the plurality of peripheral devices further includes: obtaining identifying information for individual ones of the plurality of peripheral devices; obtaining respective maximum speed requirements of the individual ones of the plurality of peripheral devices based, at least in part, on the identifying information; obtaining usage information for the individual ones of the plurality of peripheral devices; and determining actual speeds used by the individual ones of the plurality of peripheral devices based, at least in part, on the respective maximum speed requirements and the usage information for the individual ones of the plurality of peripheral devices.

In some embodiments, recommending the second configuration for connecting the one or more of the plurality of peripheral devices to the one or more of the plurality of ports further includes: determining respective actual speeds used by individual ones of the plurality of peripheral devices; executing a knapsack algorithm to determine a best fit for connecting the plurality of peripheral devices to the plurality of ports based, at least in part, on the respective actual speeds used by the individual ones of the plurality of peripheral devices; and recommending the best fit for connecting the plurality of peripheral devices to the plurality of ports as the second configuration.

In some embodiments, recommending the second configuration for connecting the one or more of the plurality of peripheral devices to the one or more of the plurality of ports further includes: executing a knapsack algorithm to determine a best fit for connecting the plurality of peripheral devices to the plurality of ports based, at least in part, on one or more of the following criteria: (a) actual speeds required by individual ones of the plurality of peripheral devices, (b) priority of the individual ones of the plurality of peripheral devices based, at least in part, on respective times the respective individual ones of the plurality of peripheral devices are connected to the IHS, (c) power requirements of the individual ones of the plurality of peripheral devices, or (d) usage time by an end user of the individual ones of the plurality of peripheral devices; and recommending the best fit for connecting the plurality of peripheral devices to the plurality of ports as the second configuration.

In another illustrative, non-limiting embodiment, a memory storage device has program instructions stored thereon that, upon execution by a processor, may cause the processor to: obtain real-time speed, priority, and power information for at least one of a plurality of peripheral devices coupled to at least a first one of a plurality of ports of an Information Handling System (IHS); and recommend that the at least one peripheral device be coupled to at least a second one of the plurality of ports based, at least in part, on the real-time speed, priority, and power information.

In some embodiments, to obtain the real-time speed information for the at least one peripheral device, the program instructions further cause the processor to: obtain identifying information for the at least one peripheral device; obtain a maximum speed requirement of the at least one peripheral device based, at least in part, on the identifying information; obtain usage information for the at least one peripheral device when coupled to the at least first one of the plurality of ports; and determine, by a machine learning algorithm, the real-time speed used by the at least one peripheral device based, at least in part, on the maximum speed requirement and the usage information for the at least one peripheral device.

In some embodiments, to recommend that the at least one peripheral device be coupled to the at least second one of the plurality of ports, the program instructions further cause the processor to: execute a knapsack algorithm to determine a best fit for connecting the at least one peripheral device to the plurality of ports based, at least in part, on the real-time speed, priority, and power information for the at least one peripheral device; and determine the at least second one of the plurality of ports for the recommendation based, at least in part, on the best fit.

In some embodiments, to recommend that the at least one peripheral device be coupled to the at least second one of the plurality of ports, the program instructions further cause the processor to: execute an algorithm to determine a best fit for connecting the at least one peripheral device to the plurality of ports based, at least in part, on at least the following criteria: (a) the real-time speed required by the at least one peripheral device, (b) the priority of the at least one peripheral device based, at least in part, on a connection time of the at least one peripheral device, and (c) a power requirement of the at least one peripheral device; and determine the at least second one of the plurality of ports for the recommendation based, at least in part, on the best fit.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 depicts a block diagram of examples of components of an Information Handling System (IHS), according to some embodiments.

FIG. 2 depicts an expansion of a user's workspace as the user introduces new devices/peripherals into the workspace, such that the ports of the client device are not available, according to some embodiments.

FIG. 3 depicts a block diagram of an example of an architecture of managing an optimal port setup for workspaces, according to some embodiments.

FIG. 4 depicts a block diagram of an example of a system of managing an optimal port setup for workspaces, according to some embodiments.

FIG. 5 depicts a block diagram of an example of a method of managing an optimal port setup for workspaces, according to some embodiments.

FIG. 6 depicts a flowchart of an example of a method of managing an optimal port setup for workspaces, according to some embodiments.

FIG. 7 depicts a flowchart of an example of a method for identifying a best fit port using a knapsack algorithm, according to some embodiments.

FIG. 8 depicts a sequence diagram of an example of a method of managing an optimal port setup for workspaces, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display.

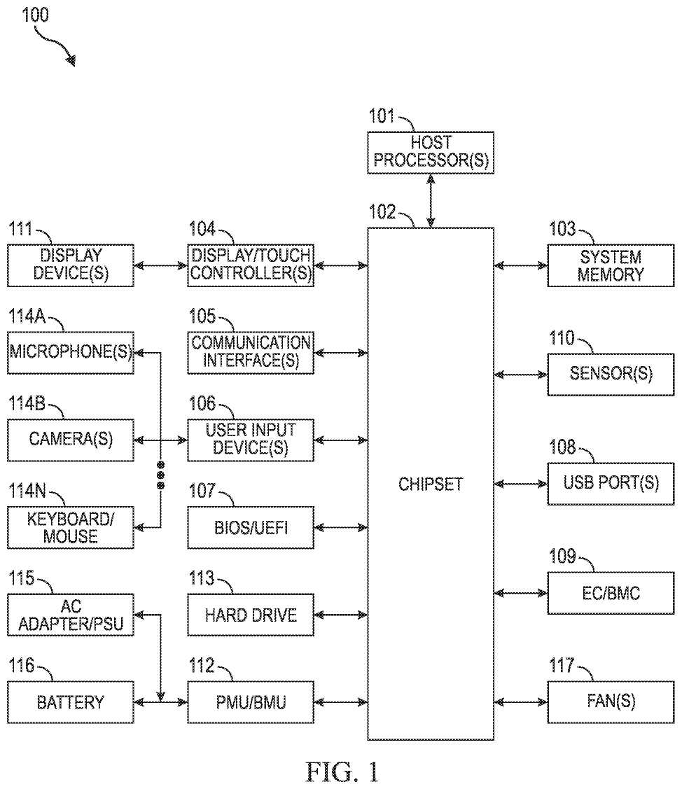

An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

In the context of IHSs, each workspace (e.g., an office, a conference room, a home office, a shared workspace, etc.) may include its own distinct set of peripheral devices (e.g., an external camera or webcam, an external microphone, an external speaker, a keyboard, a mouse, a printer, etc.). When a user (or employee) arrives at a workspace, they may bring their IHSs into the workspace and then choose between using: (a) peripheral devices integrated into their IHS, or (b) external peripheral devices found in that workspace.

In some cases, when a user arrives at a particular workspace, they may couple their IHS to one or more peripheral devices via a Workspace Managing Device (WMD) such as a dock, docking station, intelligent hub, external display, wireless KVM, or other IHS. Additionally, or alternatively, the IHS may be directly coupled to one or more peripheral devices using any suitable wired or wireless communication protocol. Yet additionally, or alternatively, a workspace may be served by one of a plurality of distributed Access Points (APs) for network/Internet connectivity, such as wireless routers or the like.

In the modern enterprise, a hybrid workplace model combines office and remote work to offer flexibility and support to employees. Under the model, employees carry their IHSs to and from the office, and directly connect any peripheral devices (e.g., monitor, keyboard, mouse, docks, etc.) available in their current workspace.

The inventors hereof have determined that, in a hybrid workspace model, it is important for the user moving across home and office environments to get the same working experience irrespective of their location for continued productivity.

For example, a user may utilize a dual monitor setup at home with span mode, but when the user goes to the office, they may have access to a single monitor instead. Once the user reaches the office workspace, they connect their IHS to the workspace's dock, which adapts his environment to single monitor use, and the user's dual monitor productivity preference is not taken into consideration.

To illustrate further, consider a first hypothetical scenario, where a user has all high-speed ports in the client device busy and the user buys a 4 k monitor. The only way this monitor will function is if connected to a high-speed port. The user has a 4 k camera connected to a high-speed port, but the user hardly uses that camera and whenever he does use, he uses the camera at 1080p and does not use any AI features like auto-framing which requires a high-speed port. This means that the context of the workspace has changed.

In this case, some of the systems and methods described herein may recommend whether the user should rewire the workspace, such as by unplugging the 4 k camera from the high-speed port and plugging it into a low-speed available port, and plugging the 4 k monitor into the high-speed port. This will ensure that the user gets all capabilities for the monitor and the camera.

In a second hypothetical scenario, a user has all ports used up. He has 2 high-speed ports and has connected 4 k monitor and 4 k camera to each high-speed port. The user introduces a new peripheral into the workspace. The user does not use all capabilities of the 4 k camera, he uses it in only 1080p mode which does not require a high-speed port.

In this case, some of the systems and methods described herein may provide a recommendation to connect the new peripheral, such as recommending the user to unplug the camera from the high-speed port and plugging in a hub into that port, and plugging the camera into one of the ports on the hub, and plugging the other peripheral also into the same hub. Another recommendation might be to plug the camera into a port of the monitor to free up a port which can be used for new introduced peripheral.

In a third hypothetical scenario, a user has introduced a 4 k monitor into the workspace and connected it to a highspeed port. The entire configuration of the workspace has changed because now the monitor's ports are also available.

In this case, some of the systems and methods described herein may recommend a new workspace setup by using data from user's interaction with the peripherals for capability, where the new workspace setup might involve plugging in some peripherals into the monitor for an enhanced user experience.

In a fourth hypothetical scenario, an Information Technology Decision Maker (“ITDM”) is collecting information about the peripheral usage behavior for a user. The ITDM knows that the user never uses the external keyboard but uses the external mouse extensively.

In this case, some of the systems and methods described herein may suggest that the ITDM re-deploy the external keyboard while providing an upgraded external mouse to the user. This will save money for the ITDM.

Accordingly, in various embodiments, systems and methods described herein may provide management of optimal port setup for workspaces. The user's productivity profile and/or preferences may be automatically adapted for hybrid work setup to suit the user's requirements. These systems and methods may identify all the connected peripherals in the workspace, get the speed drawn by the connected peripherals using a service and store them in cloud database, and identify that a new device has been introduced into the workspace and recommend optimal workspace setup thus enabling business continuity and allowing the user to spend less time setting up their IHS and workspaces.

In each of the aforementioned scenarios, to prevent the user from continuing to use low performing ports, reconnecting low performing peripheral devices through trial-and-error, and/or having to become more technical about the peripheral devices, these systems and methods may provide an Operating System (OS) (e.g., WINDOWS, MACOS, iOS, ANDROID, LINUX, etc.), peripheral device, communication port, and protocol-independent framework for automatically managing an optimal port setup for workspaces.

FIG. 1 is a block diagram of hardware components of IHS 100, which may be used to implement managing an optimal port setup for workspaces.

As depicted, IHS 100 includes host processor(s) 101. In various embodiments, IHS 100 may be a single-processor system, or a multi-processor system including two or more processors. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101.

Chipset 102 may also be coupled to communication interface(s) 105 to enable communications between IHS 100 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 105 may also be used to communicate with certain peripherals devices (e.g., BT speakers, microphones, headsets, etc.). Moreover, communication interface(s) 105 may be coupled to chipset 102 via a Peripheral Component Interconnect Express (PCIe) bus, or the like.

Chipset 102 may be coupled to display/touch controller(s) 104, which may include one or more or Graphics Processor Units (GPUs) on a graphics bus, such as an Accelerated Graphics Port (AGP) or PCIe bus. As shown, display/touch controller(s) 104 provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be provided as a single continuous display, or as two or more discrete displays.

Chipset 102 may provide host processor(s) 101 and/or display/touch controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 102 may also provide host processor(s) 101 with access to one or more Universal Serial Bus (USB) ports 108, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc.

Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.)

In certain embodiments, chipset 102 may further provide an interface for communications with hardware sensors 110.

Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

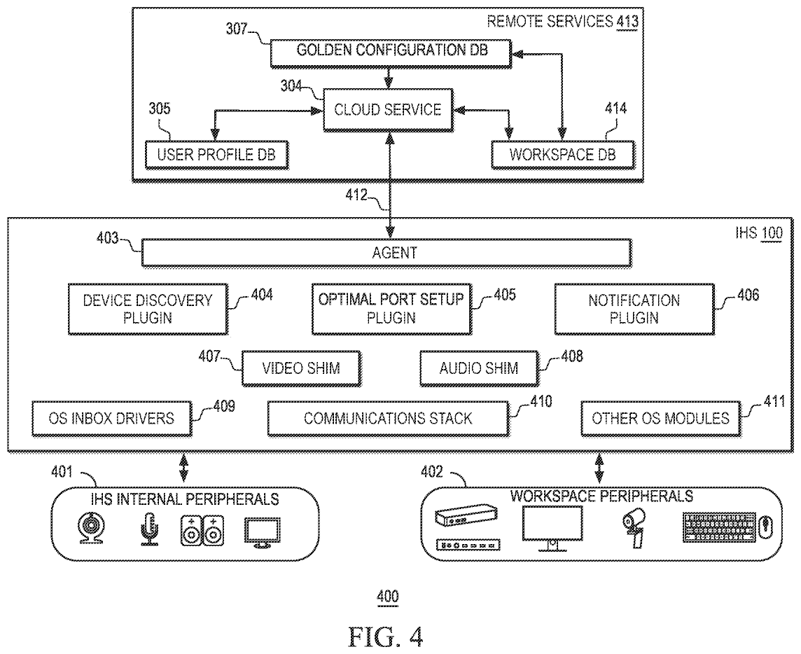

Upon booting of IHS 100, host processor(s) 101 may utilize program instructions of Basic Input/Output System (BIOS) 107 to initialize and test hardware components coupled to IHS 100 and to load host OS 400 (FIG. 4) for use by IHS 100. BIOS 107 provides an abstraction layer that allows host OS 400 to interface with certain IHS components 100. Relying upon the hardware abstraction layer provided by BIOS 107, software stored in system memory 103 and executed by host processor(s) 101 can interface with certain I/O devices that are coupled to IHS 100.

The Unified Extensible Firmware Interface (UEFI) was designed as a successor to BIOS. As a result, many modern IHSs utilize UEFI in addition to or instead of a BIOS. As used herein, BIOS 107 is intended to also encompass a UEFI component.

Embedded Controller (EC) or Baseboard Management Controller (BMC) 109 is operational from the very start of each IHS power reset and handles various tasks not ordinarily handled by host processor(s) 101. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, num lock, battery, ac, power, wireless LAN, sleep, etc.), managing PMU/BMU 112, alternating current (AC) adapter/Power Supply Unit (PSU) 115 and/or battery 116, allowing remote diagnostics and remediation over network(s) 103, etc.

For example, EC/BMC 109 may implement operations for interfacing with power adapter/PSU 115 in managing power for IHS 100. Such operations may be performed to determine the power status of IHS 100, such as whether IHS 100 is operating from AC adapter/PSU 115 and/or battery 116.

Firmware instructions utilized by EC/BMC 109 may also be used to provide various core operations of IHS 100, such as power management and management of certain modes of IHS 100 (e.g., turbo modes, maximum operating clock frequencies of certain components, etc.).

In addition, EC/BMC 109 may implement operations for detecting certain changes to the physical configuration or posture of IHS 100. For instance, when IHS 100 as a 2-in-1 laptop/tablet form factor, EC/BMC 109 may receive inputs from a lid position or hinge angle sensor 110, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some cases, EC/BMC 109 may be configured to identify any number of IHS postures, including, but not limited to: laptop, stand, tablet, tent, or book. For example, when display(s) 111 of IHS 100 is open with respect to a horizontal keyboard portion, and the keyboard is facing up, EC/BMC 109 may determine IHS 100 to be in a laptop posture. When display(s) 111 of IHS 100 is open with respect to the horizontal keyboard portion, but the keyboard is facing down (e.g., its keys are against the top surface of a table), EC/BMC 109 may determine IHS 100 to be in a stand posture.

When the back of display(s) 111 is closed against the back of the keyboard portion, EC/BMC 109 may determine IHS 100 to be in a tablet posture. When IHS 100 has two display(s) 111 open side-by-side, EC/BMC 109 may determine IHS 100 to be in a book posture. When IHS 100 has two displays open to form a triangular structure sitting on a horizontal surface, such that a hinge between the displays is at the top vertex of the triangle, EC/BMC 109 may determine IHS 100 to be in a tent posture. In some implementations, EC/BMC 109 may also determine if display(s) 111 of IHS 100 are in a landscape or portrait orientation.

In some cases, EC/BMC 109 may be installed as a Trusted Execution Environment (TEE) component to the motherboard of IHS 100.

Additionally, or alternatively, EC/BMC 109 may be configured to calculate hashes or signatures that uniquely identify individual components of IHS 100. In such scenarios, EC/BMC 109 may calculate a hash value based on the configuration of a hardware and/or software component coupled to IHS 100. For instance, EC/BMC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC/BMC 109 may later recalculate the hash value for a component may compare it against the reference hash value to determine if any modifications have been made to the component, thus indicating that the component has been compromised. In this manner, EC/BMC 109 may validate the integrity of hardware and software components installed in IHS 100.

In various embodiments, IHS 100 may be coupled to an external power source (e.g., AC outlet or mains) through AC adapter/PSU 115. AC adapter/PSU 115 may include an adapter portion having a central unit (e.g., a power brick, wall charger, or the like) configured to draw power from an AC outlet via a first electrical cord, convert the AC power to direct current (DC) power, and provide DC power to IHS 100 via a second electrical cord.

Additionally, or alternatively, AC adapter/PSU 115 may include an internal or external power supply portion (e.g., a switching power supply, etc.) connected to the second electrical cord and configured to convert AC to DC. AC adapter/PSU 115 may also supply a standby voltage, so that most of IHS 100 can be powered off after preparing for hibernation or shutdown, and powered back on by an event (e.g., remotely via wake-on-LAN, etc.). In general, AC adapter/PSU 115 may have any specific power rating, measured in volts or watts, and any suitable connectors.

IHS 100 may also include internal or external battery 116. Battery 116 may include, for example, a Lithium-ion or Li-ion rechargeable device capable of storing energy sufficient to power IHS 100 for an amount of time, depending upon the IHS's workloads, environmental conditions, etc. In some cases, a battery pack may also contain temperature sensors, voltage regulator circuits, voltage taps, and/or charge-state monitors.

Power Management Unit (PMU) 112 governs power functions of IHS 100, including AC adapter/PSU 115 and battery 116. For example, PMU 112 may be configured to: monitor power connections and battery charges, charge battery 116, control power to other components, devices, or ICs, shut down components when they are left idle, control sleep and power functions (“on” and “off”), manage interfaces for built-in keypad and touchpads, regulate real-time clocks (RTCs), etc.

In some implementations, PMU 112 may include one or more Power Management Integrated Circuits (PMICs) configured to control the flow and direction or electrical power in IHS 100. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

Additionally, or alternatively, PMU 112 may include a Battery Management Unit (BMU) (referred to collectively as “PMU/BMU 112”). AC adapter/PSU 115 may be removably coupled to a battery charge controller within PMU/BMU 112 to provide IHS 100 with a source of DC power from battery cells within battery 116 (e.g., a lithium ion (Li-ion) or nickel metal hydride (NiMH) battery pack including one or more rechargeable batteries). PMU/BMU 112 may include non-volatile memory and it may be configured to collect and store battery status, charging, and discharging information, and to provide that information to other IHS components.

Examples of information collected and stored in a memory within PMU/BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 112. Power draw data may also be monitored with respect to individual components or devices of IHS 100. Whenever applicable, PMU/BMU 112 may administer the execution of a power policy, or the like.

IHS 100 may also include one or more fans 117 configured to cool down one or more components or devices of IHS 100 disposed inside a chassis, case, or housing. Fan(s) 117 may include any fan inside, or attached to, IHS 100 and used for active cooling. Fan(s) 117 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components of IHS 100 (e.g., chipset 102, display/touch controller(s) 104, communication interface(s) 105, EC/BMC 109, etc.) may be replaced by discrete devices within a heterogenous computing platform (e.g., a System-On-Chip or “SoC”). As such, IHS 100 may assume different form factors including, but not limited to: servers, workstations, desktops, laptops, appliances, video game consoles, tablets, smartphones, etc.

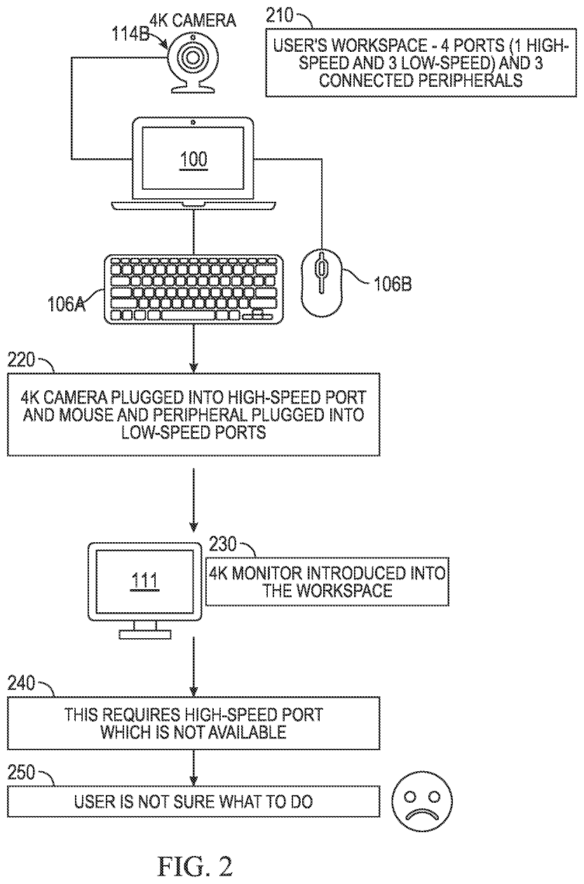

FIG. 2 depicts an expansion of a user's workspace as the user introduces new devices/peripherals into the workspace, such that the ports of the client device are not available, according to some embodiments. FIG. 2 is similar to the fourth hypothetical scenario, detailed above, where a user has all high-speed ports in the client device busy. As detailed at 210, the user has an IHS 100, where the user's workspace consists of 4 ports, 1 high-speed port and 3 low-speed ports. The user has 3 connected peripherals. As detailed in 230, then the user buys a 4 k monitor 111. As detailed in 240, the only way this monitor will function is if connected to a high-speed port. However, as detailed in 220, the user has a 4 k camera 114B connected to the high-speed port, and a keyboard 106A and a mouse 106B plugged into 2 of the 3 low-speed ports. Therefore, the high-speed port is not available, as stated in 240. As detailed in 250, the user is not sure what to do in this instance.

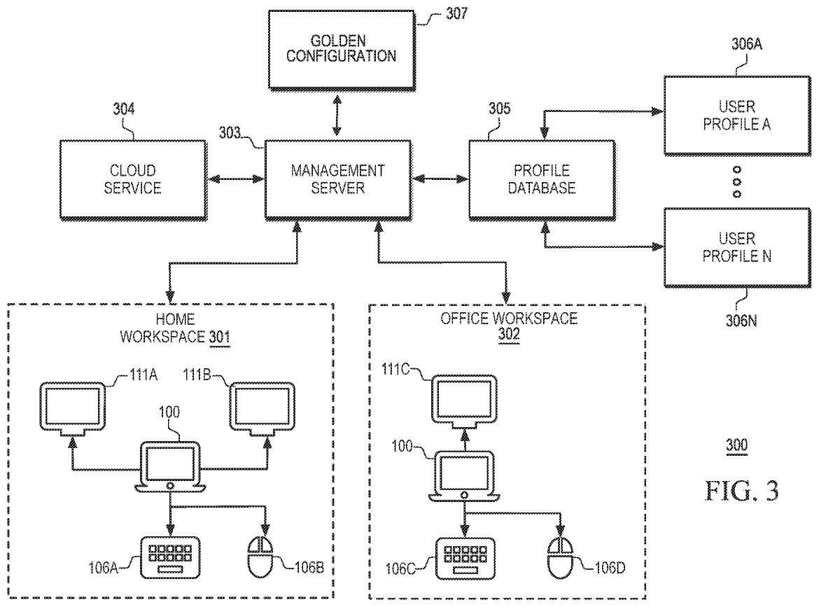

FIG. 3 depicts a block diagram of an example of architecture 300 of managing an optimal port setup for workspaces. As shown, an IHS user (e.g., the employee of an enterprise with hybrid work arrangements, etc.) may operate IHS 100 in home workspace 301 and/or office workspace 302.

When in workspace 301, IHS 100 has access to dual displays 111A and 111B, as well as keyboard 106A and mouse 106B. Conversely, when in office workspace 302, IHS 100 has access to single display 111C, keyboard 106C, and mouse 106D.

Both home and office workspaces 301 and 302 may be in communication with remote management server 303 (e.g., via the Internet) configured to manage workspaces using productivity profiles, as described in more detail below. Management server 303 may be in communication with cloud service 304 and user productivity profile database 305, which stores profiles 306A-N. Management server 303 may be in communication with golden configuration 307. Golden configuration 307 hosts the capabilities and features for all devices and peripherals. This information will be used to determine the contract established between the peripheral and the connected port. This contract determines the speed that will be provided by the port to the peripheral.

In operation, IHS 100 registers with management server 303 and monitors the user's utilization of various peripheral devices in a given workspace (e.g., home workspace 301). IHS 100 publishes a user's workspace definition and/or productivity profile to management server 303, which saves the workspace definition and/or profile in database 305 (or in other embodiments, in a database hosted by the cloud service 304). When IHS 100 connects to management server 303 from another workspace (e.g., office workspace 302), it may publish the capabilities (e.g., peripheral devices, configurations, etc.) of that workspace as well. The management server 303 can get the standard speed requirement of the peripherals from the Golden configuration database 307. The management server 303 can store this information in database 305 (or in other embodiments, in the cloud 304) along with the workspace definition.

Management server 303 may then get the configuration at which the peripherals are operating using respective APIs (camera API, monitor API, etc.). For e.g., the resolution at which the monitor 11C is operating, camera resolution, etc. Using static information from the golden configuration 307 and the obtained peripheral real time configuration, the management server 303 can feed this information into a supervised machine learning model (such as a model provided by the cloud service 304) to predict the current speed requirement of the peripheral. The model can be a TensorFlow model that takes, as input, the static and dynamic peripheral parameters, and predicts the speed at which the peripheral is currently running. This can be a model that will determine the real-time speed drawn by peripherals, and can store it in the database 305 (or in other embodiments, in a database hosted by the cloud service 304) linked to a user and the workspace definition. This can be a Keras TensorFlow model, in some embodiments.

Management server 303 may then use an algorithm (e.g., a Knapsack algorithm) to find a best fit port configuration based on the real-time speed of peripheral, in some embodiments. In some other embodiments, the Management server 303 may communicate with the cloud service 304 to find the best fit port configuration. The Management server 303 may then generate a workspace recommendation (e.g., for the most optimal way to setup the workspace, etc.). Once the workspace recommendation is produced, IHS 100 may retrieve an applicable productivity profile and it may apply it to its current workspace.

FIG. 4 depicts a block diagram of an example of system 400 of managing an optimal port setup for workspaces. In some embodiments, system 400 may include IHS 100 coupled to IHS-integrated peripheral devices 401 and to external, workspace peripherals 402. To enable the management of workspaces using productivity profiles, IHS 100 may also be coupled to remote services (or “backend”) 413 via Application Programming Interface (API) 412 (e.g., a REpresentational State Transfer or “REST” API, or the like), over a network (e.g., the Internet).

Within IHS 100, a kernel space may include: OS inbox drivers 409, communications stack 410, and other OS modules 411. Moreover, a user space overlaying the kernel space may include: agent 403, device discovery plugin 404, optimal port setup plugin 405, notification plugin 406, video shim module 407, and audio shim module 408.

Agent 403 may be responsible for loading other plugins and modules, and for handling all incoming and outgoing events from and to cloud service 304.

Device discovery plugin 404 may be responsible for discovering the devices connected to a workspace (static and dynamically connected peripherals). Optimal port setup plugin 405 may be responsible for identifying user profiles containing peripherals utilized with usage duration, as well as user preferences, settings, configurations, priorities, and other data usable in the management of workspaces, and providing an optimal port setup recommendation that is based on dynamic information about how a user is utilizing devices and peripherals in workspace. In some embodiments, the optimal port setup recommendation is not solely based on the capability of ports and peripherals, but also includes information about the deployment configuration of devices and peripherals, in order to provide a truly optimized and personalized experience.

Notification plugin 406 may be responsible for handling notifications to the user of IHS 100. Video shim module 407 and audio shim module 408 may be configured to handle peripheral device-level abstractions, including any composite devices (e.g., docks, hubs, etc.).

Within remote services 413, cloud service 304 is coupled to user productivity profile database 305, workspace database 414, and golden configuration database 307. Cloud service 304 may be configured to use an algorithm (e.g., a Knapsack algorithm) to find a best fit port configuration based on the real-time speed of peripheral, in some embodiments. The real-time speed of peripheral can be determined by a supervised machine learning model to predict the current speed requirement of the peripheral, in some embodiments. Cloud service 304 may then generate a workspace recommendation (e.g., for the most optimal way to setup the workspace, etc.). This workspace recommendation can be based on the predicted speed drawn by the peripherals, in some embodiments. Cloud service 304 may also be configured to select or identify a user productivity profile for use based upon data published by agent 303, and to generate workspace recommendations (e.g., a different workspace, to add, procure, or replace a device, to remove an unnecessary device, etc.) in some embodiments.

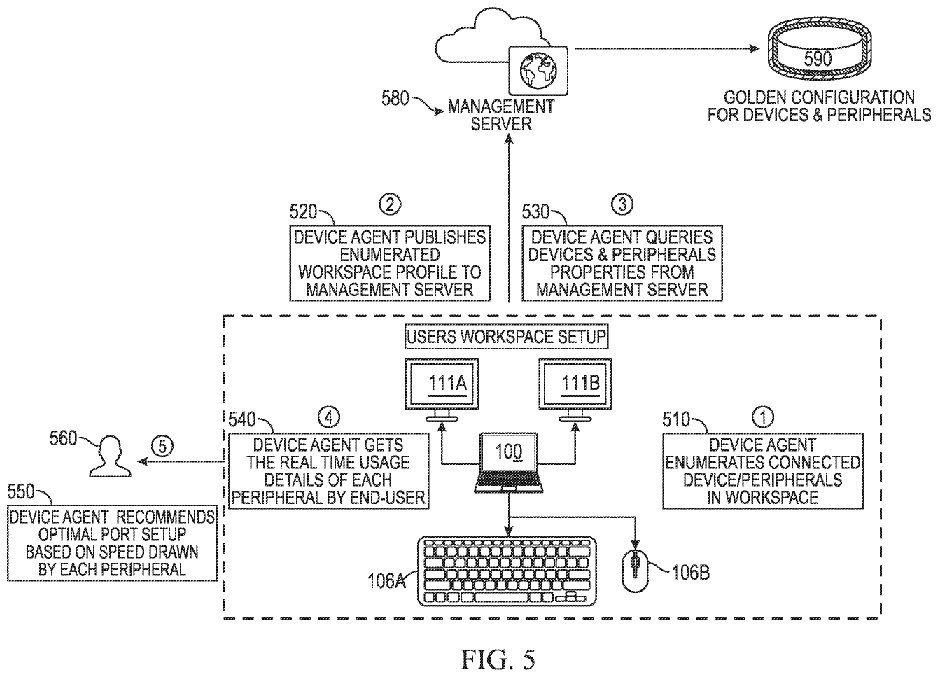

FIG. 5 depicts a block diagram of an example of a method of managing an optimal port setup for workspaces, according to some embodiments. FIG. 5 begins at 510, where the device agent (e.g., such as Agent 403 of FIG. 4) on the IHS 100 enumerates all the connected devices and peripherals in the workspace. In the example of FIG. 5, the connected devices and peripherals include two connected monitors (111A, 111B), a keyboard 106A, and a mouse 106B. Then at 520, this information, which can be the enumerated workspace profile, is saved in the Management Server 580 (which might be located in the cloud, in some embodiments) so that it can be used later. The device agent can, in some embodiments, publish this information to the Management Server 580, so that the management server can save it.

Then at 530, the device agent uses the workspace definition information to get configuration details about the devices and peripherals present in the workspace. The device agent can query the Management Server 580 for this information. This information can be stored in a Golden Configuration for devices and peripherals 590, from which the Management Server 580 obtains the information. At step 540, the device agent can get the real time usage information for the devices and peripherals by using Device APIs. Then at step 550, the device agent can calculate the real-time (i.e., current actual) speed being drawn by devices and peripherals. The device agent can, in some embodiments, run the Intelligent Agent which calculates this real-time speed. The device agent can, in some embodiments, then use an algorithm (e.g., a Knapsack algorithm) to find a best fit port configuration based, at least in part, on the real-time speed of the devices and peripherals. The device agent can then provide a recommendation to the user for an optimal way to setup workspace (e.g., an optimal port setup).

In some embodiments, the IHS might be a laptop, a desktop personal computer, a tablet, or another kind of client device connected to multiple peripherals. In such embodiments, a device agent can use an API to get configuration details and/or usage information of the connected peripherals e.g., camera resolution, fps, user set parameters. Then an AI agent can calculate the speed drawn by the peripherals using the configuration details and/or usage information. An algorithm (e.g., a Knapsack algorithm) to find a best fit port configuration based, at least in part. on the speed drawn by the devices and peripherals.

In other embodiments, the IHS might be smart peripheral, such as a docking station. In one such embodiment, a laptop might be connected to a docking station that is connected to a monitor. In such embodiments, the smart peripheral, (e.g., docking station) can collect information about the configuration and/or usage information of itself and/or the other connected peripherals. An AI agent on the smart peripheral can then calculate the speed drawn by peripherals using the configuration details and/or usage information. The smart peripheral can then calculate the optimal port setup, or information can then be received by the client device to calculate optimal port setup, depending on the embodiment.

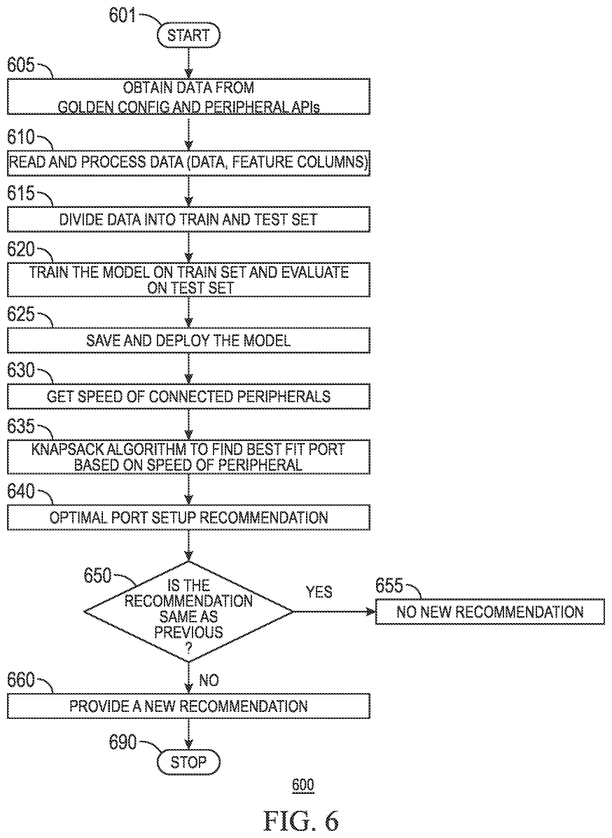

FIG. 6 depicts a flowchart of an example of a method of managing an optimal port setup for workspaces, according to some embodiments. In some embodiments, method 600 may be performed, at least in part, by system 400 in the course of managing workspaces. Particularly, method 600 begins at 601.

At 605, method 600 may include obtaining data from a golden configuration and/or peripheral APIs. The method 600 can use a device plugin to get information about all wired connected devices/peripherals in the workspace, in some embodiments. These peripherals might be connected directly to the client machine, or via a hub, dock or to other devices and peripherals in the workspace. For e.g., some peripherals might be connected to a monitor in the workspace. The method can store this information in a database. The database might be located in the cloud, such as a MongoDB, in some embodiments. The method 600 can get the speed drawn by the connected peripherals (e.g., using a service) and store them in database as well. The method 600 can also use a Golden Configuration to get the standard speed requirement of the peripheral. The

Golden configuration can host the capabilities and features for all devices and peripherals. This information can be used to determine the contract established between the peripheral and the connected port, in some embodiments. This contract can determine the speed that will be provided by the port to the peripheral. The golden configuration can provide APIs to get information from the config and API to populate information into the golden configuration, in some embodiments. The method 600 can then store this information in the database with the workspace definition.

At 610, method 600 can include reading and processing the data, such as into data and feature columns. At 615, the method 600 can divide the data into a training set and a testing set. At 620, the method 600 can train a machine learning model on the training data set, and evaluate the machine learning model on the testing data set. At 625, method 600 can save and deploy the trained and tested machine learning model. The machine learning model can, in some embodiments, be a TensorFlow model that takes as input the static and dynamic peripheral parameters and predicts the speed at which the peripheral is currently running. This can be a model that determines the real time speed drawn by peripherals. The service can store this determined real-time speed drawn by the peripherals in the database, and it can be linked to a user and the workspace definition. The machine learning model can be a Keras TensorFlow model—sequential model with one input tensor and one output tensor, 3 dense layers, a MaxPooling layer, with a learning rate of 0.001, and an activation function=‘relu’, in some embodiments.

At 630, the method 600 can get the speed of the connected peripherals. In some embodiments, the method can get the configuration at which the peripherals are operating using respective APIs (camera API, monitor API, etc.). For example, the method can get the resolution at which monitor is operating, the camera resolution, etc. Using static information from the golden configuration and the peripheral real-time configuration, the method 600 can feed this information into the deployed machine learning model to predict the current speed requirement of the peripheral.

At 635, the method 600 can use an algorithm (e.g., a Knapsack algorithm) to find a best fit port configuration based, at least in part, on the real-time speed of peripheral, in some embodiments. In some other embodiments, the method 600 may communicate with a cloud service 304 to find the best fit port configuration. At 640, the method 600 may then generate a workspace recommendation (e.g., for an optimal way to setup the ports of the workspace, etc.).

At 650, the method 600 can determine whether the recommendation is the same as the previous recommendation. If the recommendation is the same as the previous recommendation, then, at 655, no new recommendation is provided. If the recommendation is not the same as the previous recommendation, then a new recommendation is provided at 660. Finally, at 690, the method 600 is finished.

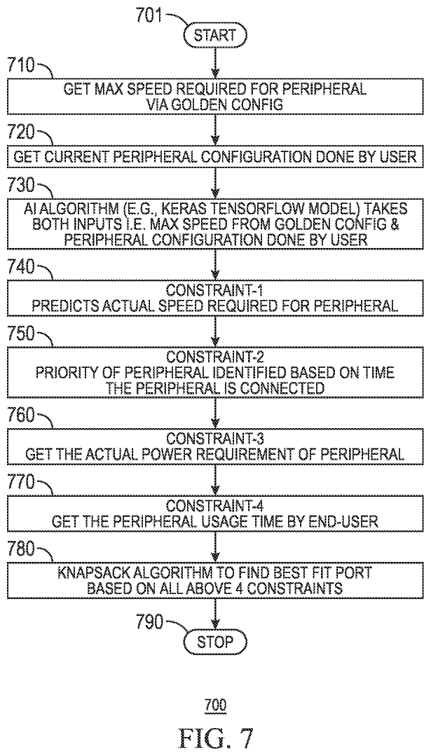

FIG. 7 depicts a flowchart of an example of a method for identifying a best fit port using a knapsack algorithm, according to some embodiments. In some embodiments, method 700 may be performed, at least in part, by system 400 in the course of managing workspaces. Particularly, method 700 begins at 701.

At 710, the method 700 gets the maximum speed required for a peripheral via the golden configuration (e.g., golden configuration database). The golden configuration can host the capabilities and features for all devices and peripherals. This information can be used to determine the contract established between the peripheral and the connected port, in some embodiments. This contract can determine the speed that will be provided by the port to the peripheral. The golden configuration can provide APIs to get information from the config and API to populate information into the golden configuration, in some embodiments.

At 720, the method 700 can get the current peripheral configuration that is configured by the user. The method 700 can get the configuration at which the peripherals are operating using respective APIs (camera API, monitor API, etc.). For example, the method can get the resolution at which monitor is operating, the camera resolution, etc.

At 730, the method can use an AI algorithm (e.g. a Keras TensorFlow model). The AI algorithm can use the information obtained from 710 and 720 as inputs, in some embodiments. The AI algorithm can use the maximum speed from the golden configuration, and the current peripheral configuration, as inputs. The machine learning model can, in some embodiments, be a TensorFlow model that takes as input the static and dynamic peripheral parameters and predicts the speed at which the peripheral is currently running. The machine learning model can be a Keras TensorFlow model-sequential model with one input tensor and one output tensor, 3 dense layers, a MaxPooling layer, with a learning rate of 0.001, and an activation function=‘relu’, in some embodiments.

At 740, the AI algorithm can predict the actual speed required for a peripheral based on the inputs. The AI algorithm can predict the speed at which the peripheral is currently running. The AI algorithm can determine the real time speed drawn by peripherals. This predicted actual speed can be a first constraint to an algorithm (e.g., knapsack algorithm) that finds a best-fit port configuration at step 780.

At 750, the method 700 can determine the priority of a peripheral identified. This priority can be based on the time the peripheral is connected, in some embodiments. This priority can be a second constraint to the algorithm (e.g., knapsack algorithm) that finds a best-fit port configuration at step 780.

At 760, the method 700 can obtain the actual power requirement of the peripheral. This actual power requirement can be a third constraint to the algorithm (e.g., knapsack algorithm) that finds a best-fit port configuration at step 780. At 770, the method 700 can obtain the peripheral usage time by the end-user. This peripheral usage time can be a fourth constraint to the algorithm (e.g., knapsack algorithm) that finds a best-fit port configuration at step 780.

Finally, at step 780, the method 700 can use the algorithm (e.g., a Knapsack algorithm) to find a best fit port configuration based on the above 4 constraints, in some embodiments. At 790, the method 700 is finished.

However, in some embodiments, the algorithm can use some, but not all, of the above 4 constraints. In some embodiments, the algorithm can use other constraints in addition to some or all of the above 4 constraints. In some embodiments, the algorithm can use an entirely different set of constraints.

For example, the algorithm can recommend that a peripheral be coupled to a different port based on the speed, the power, or the priority of the peripheral. In some embodiments, the algorithm can provide port recommendations based on the IHS battery level. For example, the algorithm can recommend that a peripheral that's drawing a lot of power be moved to another port depending upon the IHS's battery charge level, as determined by the EC/BMC. For example, the algorithm might recommend a peripheral be connected to a USB 2.0 port instead of a USB 3.0 port, so that the current can be significantly less.

In some embodiments, the algorithm can provide port recommendations based on the IHS location. The IHS location can be determined by, for example, the IHS's IP address or GPS location. If, for example, the user is determined to be at work, then the algorithm can recommend a first port for a given peripheral. If the user is determined to be at home, the algorithm can recommend a second port for the same peripheral, in some of these embodiments.

In some embodiments, the algorithm can provide port recommendations based on based on peripheral disconnection. For example, when a peripheral is disconnected from a given port, the device agent can determine that a given port now available, and can re-check the algorithm for any new recommendations and then recommend an optimal workspace setup, in some of these embodiments.

In some embodiments, the algorithm can provide port recommendations based on based on the physical posture of the IHS. For example, if the IHS is a laptop or a tablet, the laptop or tablet can be in different physical configurations. For example, an IHS kickstand might be in different positions or states, which is one way for an IHS to be in a different physical posture. More particularly, for example, the back side of the IHS's housing can include a fixed backplate and a kickstand, where the kickstand is coupled to backplate via one or more hinges. Even more particularly, the kickstand might swivel or rotate around an axis with respect to backplate to move between a closed and open (i.e., deployed) position. In the closed configuration the kickstand might coplanar or parallel with respect to the backplate, such that housing may be placed horizontally on a flat surface. In the open configuration, the kickstand might be rotated away from backplate around the axis so that it can keep the IHS's housing standing upright (at an angle) on a horizontal surface without having to lean against another object or be held by a person. The backplate may include one or more ports that can be blocked or obstructed by the kickstand in certain positions, for example. There are many other scenarios and embodiments of IHSs where a port might become blocked or obstructed, and the above scenario should not be construed as limiting. When a port does become blocked or obstructed because of the posture of the IHS, the device agent can determine that a given port has now become unavailable, and can re-check the algorithm for any new recommendations, and then recommend an optimal workspace setup, in some embodiments. In other embodiments, the algorithm might simply determine that some ports are more preferable in certain IHS postures, and can recommend different port setups for different peripherals based on a different posture of the IHS.

For example, in a first hypothetical scenario, a user has all high-speed ports in the client device busy and the user buys a 4 k monitor. The only way this monitor will function is if connected to a high-speed port. The user has a 4 k camera connected to a high-speed port, but the user hardly uses that camera and whenever he does use, he uses the camera at 1080p and does not use any AI features like auto-framing which requires a high-speed port. This means that the context of the workspace has changed.

In this case, some of the systems and methods described herein may recommend whether the user should rewire the workspace, such as by unplugging the 4 k camera from the high-speed port and plugging it into a low-speed available port, and plugging the 4 k monitor into the high-speed port. This will ensure that the user gets all capabilities for the monitor and the camera.

In a second hypothetical scenario, a user has all ports used up. He has 2 high-speed ports and has connected 4 k monitor and 4 k camera to each high-speed port. The user introduces a new peripheral into the workspace. The user does not use all capabilities of the 4 k camera, he uses it in only 1080p mode which does not require a high-speed port.

In this case, some of the systems and methods described herein may provide a recommendation to connect the new peripheral, such as recommending the user to unplug the camera from the high-speed port and plugging in a hub into that port, and plugging the camera into one of the ports on the hub, and plugging the other peripheral also into the same hub. Another recommendation might be to plug the camera into a port of the monitor to free up a port which can be used for new introduced peripheral.

In a third hypothetical scenario, a user has introduced a 4 k monitor into the workspace and connected it to a highspeed port. The entire configuration of the workspace has changed because now the monitor's ports are also available.

In this case, some of the systems and methods described herein may recommend a new workspace setup by using data from user's interaction with the peripherals for capability, where the new workspace setup might involve plugging in some peripherals into the monitor for an enhanced user experience.

In a fourth hypothetical scenario, an Information Technology Decision Maker (“ITDM”) is collecting information about the peripheral usage behavior for a user. The ITDM knows that the user never uses the external keyboard but uses the external mouse extensively.

In this case, some of the systems and methods described herein may suggest that the ITDM re-deploy the external keyboard while providing an upgraded external mouse to the user. This will save money for the ITDM.

In a fifth hypothetical scenario, a user purchases a new peripheral device, such as from the manufacturer of the IHS. In this case, some of the systems and methods described herein may identify that a new device has been introduced into the workspace and recommend an optimal workspace setup. These embodiments can identify if the user has purchased a new device by obtaining and then using an “out for delivery” notification mechanism, or analyzing an “order history” for the user. Some of these embodiments can use an event-based method to determine if the user has plugged in a new device. Some of these embodiments can update the workspace based on an event change. Some of these embodiments can invoke a subscription to update the workspace definition. Some embodiments can then check the recommendation algorithm (e.g., the knapsack algorithm) for any new recommendations, and then recommend the most optimal workspace setup.

Therefore, in some embodiments, the systems and methods described herein get the real time speed drawn by a peripheral dynamically based on the peripheral configuration and user usage of peripheral. In some embodiments, the systems and methods described herein identify workspace optimization setup based on the dynamic speed drawn by peripherals, priority of peripherals, power drawn, peripheral usage data, and/or peripheral performance.

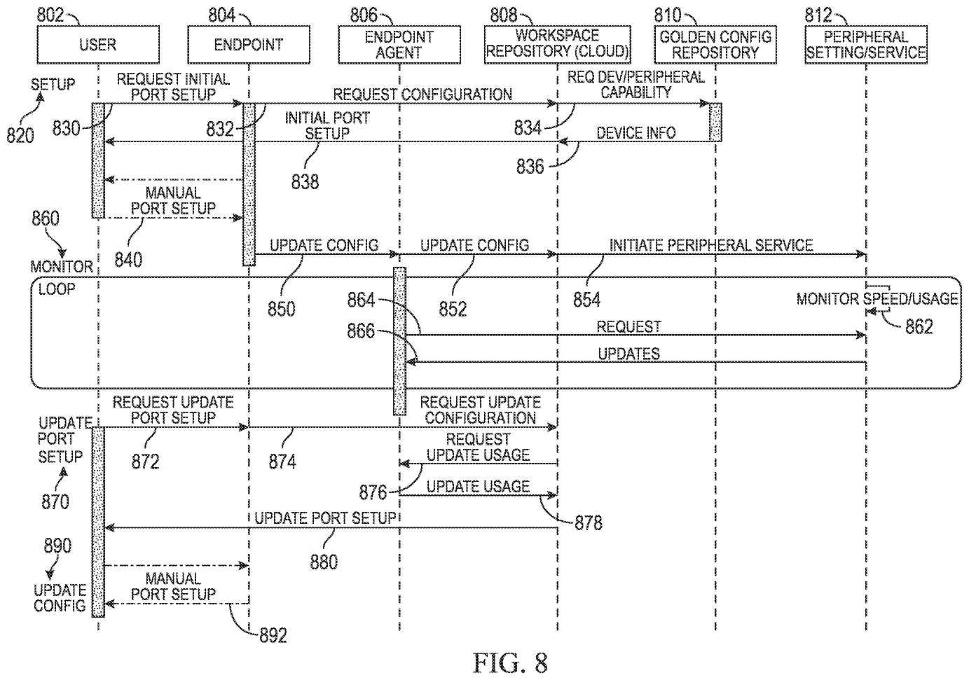

FIG. 8 depicts a sequence diagram of an example of a method of managing an optimal port setup for workspaces, according to some embodiments. The sequence diagram begins at the setup phase 820. In the setup phase 820, a user 802 requests 830 an initial port setup from an endpoint 804. The endpoint 804 requests 832 configuration information from a workspace repository 808, which may be located in the cloud. The workspace repository requests 834 device and/or peripheral capability information from the golden configuration repository 810. The golden configuration repository 810 provides device and/or peripheral information 836 to the workspace repository 808. The workspace repository 808 provides an initial port setup 838 to the endpoint 804. The endpoint 804 provides the initial port setup 838 to the user 802. The user 802 can then optionally perform a manual port setup 840 with the endpoint 804. The endpoint 804 then can update configuration 806 with the endpoint agent 806. The endpoint agent 806 then updates configuration 852 with the workspace repository 808. Then the workspace repository 808 initiates the peripheral service 854 with the peripheral service 812.

The sequence diagram also shows a monitoring phase 860. The monitoring phase 860 consists of the peripheral setting/service 812 monitoring 862 speed and/or usage of the peripherals. The endpoint agent 806 can request 864 any updates to the peripheral service 812. The peripheral service can provide updates 866 to the endpoint agent 806.

The sequence diagram also depicts a update port setup 870 phase. For the update port setup 870 phase, a user 802 requests an update to the port setup 872 to the endpoint 804. The endpoint 804 requests 874 an update to the configuration from the workspace repository 808. The workspace repository 808 can request an update to usage information 876 from the endpoint agent 806. The endpoint agent 806 can provide updated usage information 878 to the workspace repository 808. The workspace repository 808 can then provide an updated port setup 880 to the user 802. The user can then perform a manual port setup 892 with the endpoint 804 in a separate update configuration 890 phase.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. The operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
obtain information for a plurality of peripheral devices coupled to at least some of a plurality of ports of the IHS in a first configuration; and
recommend a second configuration for connecting one or more of the plurality of peripheral devices to one or more of the plurality of ports of the IHS based, at least in part, on the information.

2. The IHS of claim 1, wherein the second configuration comprises connection information for at least one peripheral device of the plurality of peripheral devices to a respective port of the plurality of ports.

3. The IHS of claim 1, wherein the plurality of ports comprise one or more higher speed ports configured to communicate with the peripheral devices at higher communication speeds than one or more lower speed ports, and wherein the second recommendation comprises a recommendation for a first set of the plurality of peripheral devices to connect to the one or more high speed ports, and a second set of the plurality of peripheral devices to connect to the one or more lower speed ports.

4. The IHS of claim 1, wherein the program instructions, upon execution, further cause the IHS to obtain the information via a composite peripheral device comprising a plurality of ports.

5. The IHS of claim 4, wherein the composite peripheral device comprises at least one of: a docking station, a display, or a hub.

6. The IHS of claim 1, wherein to obtain information for the plurality of peripheral devices, the program instructions, upon execution, further cause the IHS to:
obtain identifying information for individual ones of the plurality of peripheral devices;
obtain respective maximum speed requirements of the individual ones of the plurality of peripheral devices based, at least in part, on the identifying information;
obtain usage information for the individual ones of the plurality of peripheral devices; and
determine actual speeds used by the individual ones of the plurality of peripheral devices based, at least in part, on the respective maximum speed requirements and the usage information for the individual ones of the plurality of peripheral devices.

7. The IHS of claim 6, wherein the maximum speed requirements of the individual ones of the plurality of peripheral devices are obtained from a golden configuration datastore.

8. The IHS of claim 6, wherein the actual speeds used by the individual ones of the plurality of peripheral devices are determined by a machine learning algorithm based, at least in part, on the respective maximum speed requirements and the usage information for the individual ones of the plurality of peripheral devices.

9. The IHS of claim 1, wherein to recommend the second configuration, the program instructions, upon execution, further cause the IHS to:
determine respective actual speeds used by individual ones of the plurality of peripheral devices; and
execute a knapsack algorithm to determine a best fit for connecting the plurality of peripheral devices to the plurality of ports based, at least in part, on the respective actual speeds used by the individual ones of the plurality of peripheral devices.

10. The IHS of claim 1, wherein to recommend the second configuration, the program instructions, upon execution, further cause the IHS to:
execute a knapsack algorithm to determine a best fit for connecting the plurality of peripheral devices to the plurality of ports based, at least in part, on one or more of the following criteria: (a) actual speeds required by individual ones of the plurality of peripheral devices, (b) priority of the individual ones of the plurality of peripheral devices based, at least in part, on respective times the respective individual ones of the plurality of peripheral devices are connected to the IHS, (c) power requirements of the individual ones of the plurality of peripheral devices, or (d) usage time by an end user of the individual ones of the plurality of peripheral devices.

11. The IHS of claim 1, wherein the peripheral devices comprise at least one of: a docking station, a display, a projector, a camera, a microphone, a loudspeaker, headphones, a keyboard, a mouse, a scanner, a printer, or a tablet.

12. The IHS of claim 1, wherein to obtain information for the plurality of peripheral devices, the program instructions, upon execution, further cause the IHS to:
monitor a utilization of at least one of the peripheral devices via a port selected from the group consisting of: Universal Serial Bus (USB) Type-A, USB Type-B, USB Type-C, Lightning, Firewire, Thunderbolt, DisplayPort, High-Definition Multimedia Interface (HDMI), Digital Visual Interface (DVI), and Serial Advanced Technology Attachment (SATA).

13. A method, comprising:
obtaining actual speed information for a plurality of peripheral devices coupled to at least some of a plurality of ports of an Information Handling System (IHS) in a first configuration; and
recommending a second configuration for connecting one or more of the plurality of peripheral devices to one or more of the plurality of ports based, at least in part, on the actual speed information.

14. The method of claim 13, wherein obtaining the actual speed information for the plurality of peripheral devices further comprises:
obtaining identifying information for individual ones of the plurality of peripheral devices;
obtaining respective maximum speed requirements of the individual ones of the plurality of peripheral devices based, at least in part, on the identifying information;
obtaining usage information for the individual ones of the plurality of peripheral devices; and
determining actual speeds used by the individual ones of the plurality of peripheral devices based, at least in part, on the respective maximum speed requirements and the usage information for the individual ones of the plurality of peripheral devices.

15. The method of claim 13, wherein recommending the second configuration for connecting the one or more of the plurality of peripheral devices to the one or more of the plurality of ports further comprises:
determining respective actual speeds used by individual ones of the plurality of peripheral devices;
executing a knapsack algorithm to determine a best fit for connecting the plurality of peripheral devices to the plurality of ports based, at least in part, on the respective actual speeds used by the individual ones of the plurality of peripheral devices; and
recommending the best fit for connecting the plurality of peripheral devices to the plurality of ports as the second configuration.

16. The method of claim 13, wherein recommending the second configuration for connecting the one or more of the plurality of peripheral devices to the one or more of the plurality of ports further comprises:
executing a knapsack algorithm to determine a best fit for connecting the plurality of peripheral devices to the plurality of ports based, at least in part, on one or more of the following criteria: (a) actual speeds required by individual ones of the plurality of peripheral devices, (b) priority of the individual ones of the plurality of peripheral devices based, at least in part, on respective times the respective individual ones of the plurality of peripheral devices are connected to the IHS, (c) power requirements of the individual ones of the plurality of peripheral devices, or (d) usage time by an end user of the individual ones of the plurality of peripheral devices; and
recommending the best fit for connecting the plurality of peripheral devices to the plurality of ports as the second configuration.

17. A memory storage device having program instructions stored thereon that, upon execution by a processor, cause the processor to:
obtain real-time speed, priority, and power information for at least one of a plurality of peripheral devices coupled to at least a first one of a plurality of ports of an Information Handling System (IHS); and
recommend that the at least one peripheral device be coupled to at least a second one of the plurality of ports based, at least in part, on the real-time speed, priority, and power information.

18. The memory storage device of claim 17, wherein to obtain the real-time speed information for the at least one peripheral device, the program instructions further cause the processor to:
obtain identifying information for the at least one peripheral device;
obtain a maximum speed requirement of the at least one peripheral device based, at least in part, on the identifying information;
obtain usage information for the at least one peripheral device when coupled to the at least first one of the plurality of ports; and
determine, by a machine learning algorithm, the real-time speed used by the at least one peripheral device based, at least in part, on the maximum speed requirement and the usage information for the at least one peripheral device.

19. The memory storage device of claim 17, wherein to recommend that the at least one peripheral device be coupled to the at least second one of the plurality of ports, the program instructions further cause the processor to:
execute a knapsack algorithm to determine a best fit for connecting the at least one peripheral device to the plurality of ports based, at least in part, on the real-time speed, priority, and power information for the at least one peripheral device; and
determine the at least second one of the plurality of ports for the recommendation based, at least in part, on the best fit.

20. The memory storage device of claim 17, wherein to recommend that the at least one peripheral device be coupled to the at least second one of the plurality of ports, the program instructions further cause the processor to:
execute an algorithm to determine a best fit for connecting the at least one peripheral device to the plurality of ports based, at least in part, on at least the following criteria: (a) the real-time speed required by the at least one peripheral device, (b) the priority of the at least one peripheral device based, at least in part, on a connection time of the at least one peripheral device, and (c) a power requirement of the at least one peripheral device; and
determine the at least second one of the plurality of ports for the recommendation based, at least in part, on the best fit.
